(19) United States
(12) Patent Application Publication
(10) Pub. No.: US 2020/0286120 A1
(43) Pub. Date: Sep. 10, 2020

(54) ADVERTISING MONITORING METHOD, SYSTEM, APPARATUS, AND ELECTRONIC EQUIPMENT

(71) Applicant: ALIBABA GROUP HOLDING LIMITED, GRAND CAYMAN (KY)

(72) Inventors: Jiankang SUN, HANGZHOU (CN); Feng LIN, HANGZHOU (CN)

(21) Appl. No.: 16/885,059

(22) Filed: May 27, 2020

Related U.S. Application Data
(63) Continuation of application No. PCT/CN2020/070932, filed on Jan. 8, 2020.

(30) Foreign Application Priority Data
May 7, 2019 (CN) 201910374456.7

(51) Int. Cl. G06Q 30/02; G06F 17/16

(52) U.S. Cl. CPC G06Q 30/0242; G06F 17/16; G06Q 30/0277

(57) ABSTRACT

Advertising monitoring methods, systems, and devices, including computer programs encoded on computer storage media are provided. One of the methods includes: determining a first eigenvector of a first advertisement media resource to be monitored, wherein the first eigenvector comprises one or more first Hash values; receiving advertising time information and a second eigenvector of a second advertisement media resource, wherein the second advertisement media resource is played by a target advertising device, and the second eigenvector comprises one or more second Hash values; determining whether the advertising time information of the second advertisement media resource matches predetermined advertising time information of the first advertisement media resource and determining whether the first eigenvector matches the second eigenvector based on the one or more first Hash values and the one or more second Hash values; and determining play status of the first advertisement media resource on the target advertising.

### CROSS-REFERENCE TO RELATED APPLICATIONS

The present application is a continuation application of International Application No. PCT/CN2020/070932, filed on Jan. 8, 2020, which claims priority and the benefit of the Chinese Patent Application No. 201910374456.7 filed with China National Intellectual Property Administration (CNIPA) of the People's Republic of China on May 7, 2019. The entire contents of the above-recognized applications are incorporated herein by reference.

### TECHNICAL FIELD

The specification relates to the field of computer technology, and in particular to an advertising monitoring method, system, apparatus, and electronic equipment.

### BACKGROUND

Advertisement is a means for advertisers to disseminate information about goods or services to consumers or users through advertising media (such as electronic advertising screens) in order to promote goods or provide services. Monitoring the advisements is an act of monitoring the actual playing status of the advertisements that have been placed to avoid missed, delayed, and misplayed situations.

At present, advertisers send people to the site to monitor the advertisements placed on below-the-line (BTL) electronic advertising screens and manually report the actual playing status of the advertisements to the advertisers. Obviously, this method of manually monitoring advertisements is time-consuming, labor-intensive, and inefficient.

### SUMMARY

The embodiments of the specification provide an method, a system, a device, and an electronic equipment for monitoring an advertisement, in order to reduce the labor and time used for monitoring the advertisement and to improve the efficiency of monitoring the advertisement.

To solve the above technical problem, the embodiments of the specification are implemented as follows:

In a first aspect, an advertising monitoring method is proposed, which is applied to a monitoring server and comprises: determining a first eigenvector of a first advertisement media resource to be monitored, wherein the first eigenvector comprises one or more first Hash values; receiving advertising time information and a second eigenvector of a second advertisement media resource, wherein the second advertisement media resource is played by a target advertising device, and the second eigenvector comprises one or more second Hash values; determining whether the advertising time information of the second advertisement media resource matches predetermined advertising time information of the first advertisement media resource and determining whether the first eigenvector matches the second eigenvector based on the one or more first Hash values and the one or more second Hash values; and when the advertising time information matches the predetermined advertising information and the first eigenvector matches the second eigenvector, determining play status of the first advertisement media resource on the target advertising device is normal.

In a second aspect, an advertising monitoring device is proposed, which is applied to a monitoring server and comprises: the first determining module, configured to determine the eigenvector of the first advertisement media resource to be monitored; a receiving module, configured to receive the eigenvector and information on advertising time of the second advertisement media resource uploaded by the monitoring equipment of the target advertising device, wherein the second advertisement media resource is the advertisement media resource actually played by the target advertising device; the second determining module, configured to determine the play status of the first advertisement media resource based on matching between the eigenvector of the second advertisement media resource and that of the first advertisement media resource and matching between advertising time information and predetermined advertising time information of the first advertisement media resource.

In a third aspect, an advertising monitoring method is proposed, which is applied to monitoring equipment and comprises: outputting the second advertisement media resource to be played to the target advertising device, so that the target advertising device plays the second advertisement media resource; determining the eigenvector of the second advertisement media resource, and recording advertising time information of the second advertisement media resource; sending the eigenvector and the advertising time information of the second advertisement media resource to a monitoring server, wherein the monitoring server determines play status of the first advertisement media resource based on matching between the eigenvector of the second advertisement media resource and that of the first advertisement media resource to be monitored and matching between the advertising time information and the predetermined advertising time information of the first advertisement media resource.

In a fourth aspect, an advertising monitoring device is proposed, which is applied to monitoring equipment and comprises: an output module, configured to output the second advertisement media resource to be played to the target advertising device, so that the target advertising device plays the second advertisement media resource; a determining module, configured to determine the eigenvector of the second advertisement media resource and record advertising time information of the second advertisement media resource; a sending module, configured to send the eigenvector and the advertising time information of the second advertisement media resource to a monitoring server, wherein the monitoring server determines play status of the first advertisement media resource based on matching between the eigenvector of the second advertisement media resource and that of the first advertisement media resource to be monitored and matching between the advertising time information and predetermined advertising time information of the first advertisement media resource.

In a fifth aspect, an advertising monitoring system is proposed, which comprises monitoring equipment and a monitoring server, wherein: the monitoring equipment is configured to output the second advertisement media resource to be played to the target advertising device, so that the target advertising device plays the second advertisement media resource; determine the eigenvector of the second advertisement media resource and record advertising time information of the second advertisement media resource; and send the eigenvector and the advertising time information of the second advertisement media resource to the monitoring server; the monitoring server is configured to determine the eigenvector of the first advertisement media resource to be monitored; receive the eigenvector and the advertising time information of the second advertisement media resource uploaded from the monitoring equipment; and determine play status of the first advertisement media resource based on matching between the eigenvector of the second advertisement media resource and that of the first advertisement media resource and matching between the advertising time information of the second advertisement media resource and predetermined advertising time information of the first advertisement media resource.

In a sixth aspect, another advertising monitoring device is proposed, the device comprises one or more processors and a non-transitory computer-readable memory coupled to the one or more processors and configured with instructions executable by the one or more processors to perform operations. The operations may include: determining a first eigenvector of a first advertisement media resource to be monitored, wherein the first eigenvector comprises one or more first Hash values; receiving advertising time information and a second eigenvector of a second advertisement media resource, wherein the second advertisement media resource is played by a target advertising device, and the second eigenvector comprises one or more second Hash values; determining whether the advertising time information of the second advertisement media resource matches predetermined advertising time information of the first advertisement media resource and determining whether the first eigenvector matches the second eigenvector based on the one or more first Hash values and the one or more second Hash values; and when the advertising time information matches the predetermined advertising information and the first eigenvector matches the second eigenvector, determining play status of the first advertisement media resource on the target advertising device is normal.

In a seventh aspect, a computer-readable storage medium is proposed, which stores instructions executable by one or more processors to cause the one or more processors to perform operations. The operations may include: determining a first eigenvector of a first advertisement media resource to be monitored, wherein the first eigenvector comprises one or more first Hash values; receiving advertising time information and a second eigenvector of a second advertisement media resource, wherein the second advertisement media resource is played by a target advertising device, and the second eigenvector comprises one or more second Hash values; determining whether the advertising time information of the second advertisement media resource matches predetermined advertising time information of the first advertisement media resource and determining whether the first eigenvector matches the second eigenvector based on the one or more first Hash values and the one or more second Hash values; and when the advertising time information matches the predetermined advertising information and the first eigenvector matches the second eigenvector, determining play status of the first advertisement media resource on the target advertising device is normal.

In an eighth aspect, electronic equipment is proposed, comprising: a processor; and a memory arranged to store computer-executable instructions, which when executed cause the processor to perform the following operations: outputting the second advertisement media resource to be played to the target advertising device, so that the target advertising device plays the second advertisement media resource; determining the eigenvector of the second advertisement media resource, and recording advertising time information of the second advertisement media resource; sending the eigenvector and the advertising time information of the second advertisement media resource to a monitoring server, wherein the monitoring server determines play status of the first advertisement media resource based on matching between the eigenvector of the second advertisement media resource and that of the first advertisement media resource to be monitored and matching between the advertising time information and predetermined advertising time information of the first advertisement media resource.

In a ninth aspect, a computer-readable storage medium is proposed, which stores one or more programs that, when executed by electronic equipment comprising a plurality of applications, cause the electronic equipment to perform the following operations: outputting the second advertisement media resource to be played to the target advertising device, so that the target advertising device plays the second advertisement media resource; determining the eigenvector of the second advertisement media resource, and recording advertising time information of the second advertisement media resource; sending the eigenvector and the advertising time information of the second advertisement media resource to a monitoring server, wherein the monitoring server determines play status of the first advertisement media resource based on matching between the eigenvector of the second advertisement media resource and that of the first advertisement media resource to be monitored and matching between the advertising time information and predetermined advertising time information of the first advertisement media resource.

The solution provided in the embodiments of the specification has at least one of the following technical effects: the labor and time used for advertising monitoring can be reduced and the efficiency of advertising monitoring can be improved since the monitoring server can automatically determine the play status of the first advertisement media resource without onsite manual monitoring, based on matching between the eigenvector of the second advertisement media resource actually played by the target advertising device uploaded by the monitoring equipment of the target advertising device and the eigenvector of the first advertisement media resource to be monitored, and matching between advertising time information of the second advertisement media resource and the predetermined advertising time information of the first advertisement media resource.

### BRIEF DESCRIPTION OF THE DRAWINGS

The drawings described here are used to provide a further understanding of the specification and constitute a part of the specification. The schematic embodiments of the specification and the description thereof are used to explain the specification and do not constitute an improper limitation on the specification. In the drawings:

FIG. 1 is one of the schematic architecture diagrams of the advertising monitoring system provided by the embodiments in the specification.

FIG. 2 is the schematic flow diagram of one advertising monitoring method provided by the embodiments in the specification.

FIG. 3 is the schematic flow diagram of another advertising monitoring method provided by the embodiments in the specification.

FIG. 4 is a second schematic architecture diagram of the advertising monitoring system provided by the embodiments in the specification.

FIG. 5 is a schematic structural diagram of the electronic equipment of the embodiments in the specification.

FIG. 6 is the schematic structural diagram of one advertising monitoring device provided by the embodiments in the specification.

FIG. 7 is the schematic structural diagram of another advertising monitoring device provided by the embodiments in the specification.

### DETAILED DESCRIPTION

A clear description of the technical solution of the specification is given below in combination with specific embodiments of the specification and the corresponding drawings in order to describe the purpose, technical solution, and advantages of the specification clearly. Obviously, the embodiments described here are only a part but not all of the embodiments of the specification. All other embodiments obtained by those ordinarily skilled in the art based on the embodiments in the specification without creative efforts shall fall within the protection scope of the specification.

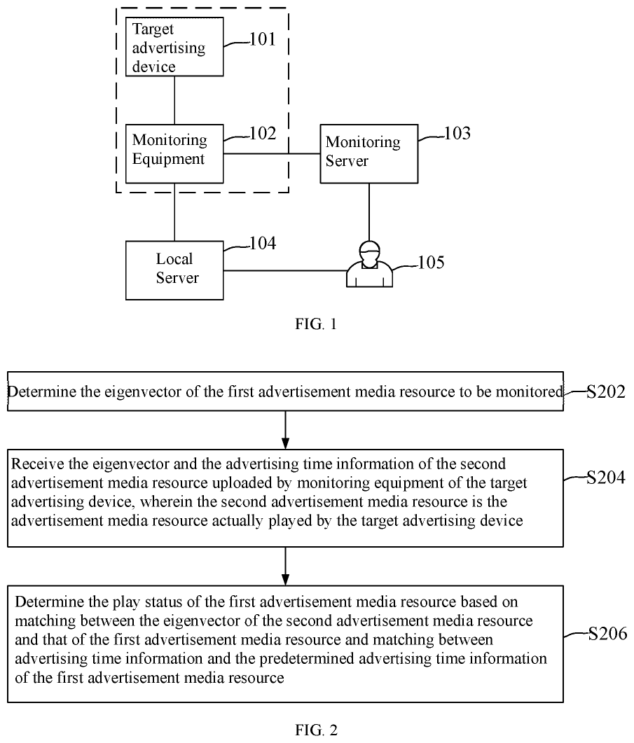

In order to reduce the labor and time used for advertising monitoring and improve the efficiency of advertising monitoring, the embodiments of the specification provide a method, a system and a device for advertising monitoring. In order to provide a comprehensive understanding of the technical solution provided by the embodiments of the specification, a description is given below of the architecture of the advertising monitoring system provided by the embodiments of the specification with reference to FIG. 1.

In reference to FIG. 1, the advertising monitoring system provided by the embodiments of the specification may comprise a target advertising device 101, monitoring equipment 102, a monitoring server 103, and a local server 104 of the monitoring equipment 102.

The target advertising device 101 may be one or more below-the-line (BTL) electronic advertising screens, such as electronic advertising screens installed in public places including elevators, bus stations, and subway stations. The monitoring equipment 102 may be a controller that outputs the advertisement media resources to be played to the target advertising device 101 and controls the playing behavior of the target advertising device 101. In real applications, the target advertising device 101 and the monitoring equipment 102 may be two pieces of independent equipment or two apparatuses of different functions in the same equipment. The local server 104 of the monitoring equipment 102 may be a server for the monitoring equipment 102 to obtain the advertisement media resources to be played by the target advertising device 101. In addition to obtaining the advertisement media resources to be played from the local server 104, advertisement media resources to be played may also be obtained from other servers (such as a network server), which is not limited in the embodiments of the specification. The monitoring server 103 is equipment for monitoring the advertisement media resources played by the target advertising device 101.

In the embodiments of the specification, the second advertisement media resource to be played that are stored in the local server 104 may be uploaded by a user 105 or downloaded from a designated server. The first advertisement media resource to be monitored that is stored in the monitoring server 103 may also be uploaded by the user 105. The user 105 may be the advertiser of the first advertisement media resource and the second advertisement media resource. It could be understood that the user 105 may be different entities when the first advertisement media resource and the second advertisement media resource are not the same.

In an example shown in FIG. 1, the monitoring equipment 102 may be connected to and communicate with the target advertising device 101 and the local server 104 through data cables, and the monitoring equipment 102 may be connected to and communicate with the monitoring server 103 through a mobile communication network.

In the embodiments of the specification, the advertisement media resources may include multimedia resources such as images and videos.

Based on FIG. 1, the advertising monitoring method provided in the embodiments of the specification is described below in combination with the detailed embodiments.

FIG. 2 is the schematic flow diagram of an advertising monitoring method provided by one embodiment of the specification, which can be applied to the monitoring server 103 shown in FIG. 1. As shown in FIG. 2, the advertising monitoring method may comprise:

Step 202: determining an eigenvector of the first advertisement media resource to be monitored.

The first advertisement media resource to be monitored may be an advertisement media resource to be played on a target advertising device at a predetermined time point for a predetermined duration.

The eigenvector of an advertisement media resource may refer to a vector that can uniquely identify the advertisement media resource. For example, the eigenvector of an advertisement media resource may be a vector formed by the eigenvalues of the advertisement media resource, where the eigenvalues include but are not limited to Hash values.

In one example, if the first advertisement media resource is a video, step 202 may comprise: simulating playing the first advertisement media resource to obtain multi-frame images contained in the first advertisement media resource; determining the Hash value of each image in the multi-frame images to obtain one or more Hash values; arranging the Hash values according to the play sequence of the multi-frame images to form a vector; and determining the vector as the eigenvector of the first advertisement media resource.

Similarly, in another example, if the first advertisement media resource is an image, step 202 may comprise: determining the Hash value of the image to obtain a Hash value, and determining a one-element vector formed by the Hash value as the eigenvector of the first advertisement media resource.

In the above two examples, calculations may be performed with algorithms such as the Message Digest Algorithm V.5 (MD5), Secure HASH Algorithm (SHA) 1, and SHA256.

In some embodiments, before step 202, the method shown in FIG. 2 may also comprise: receiving the first advertisement media resource uploaded by a user. For example, as shown in FIG. 1, the monitoring server 103 receives the first advertising media resource to be monitored that is uploaded by the user 105. Here, the user 105 may be an advertiser of the first advertisement media resource.

Step 204: receiving an eigenvector and advertising time information of the second advertisement media resource uploaded by the monitoring equipment of the target advertising device, wherein the second advertisement media resource is an advertisement media resource actually played by the target advertising device.

Similar to the eigenvector of the first advertisement media resource, if the second advertisement media resource is a video, the eigenvector of the second advertisement media resource may be a vector formed by arranging the Hash values of all the multi-frame images contained in the second advertisement media resource in the play sequence.

The advertising time information of the second advertisement media resource may include play timestamps recorded by the monitoring equipment 102 when the target advertising device plays the second advertisement media resource.

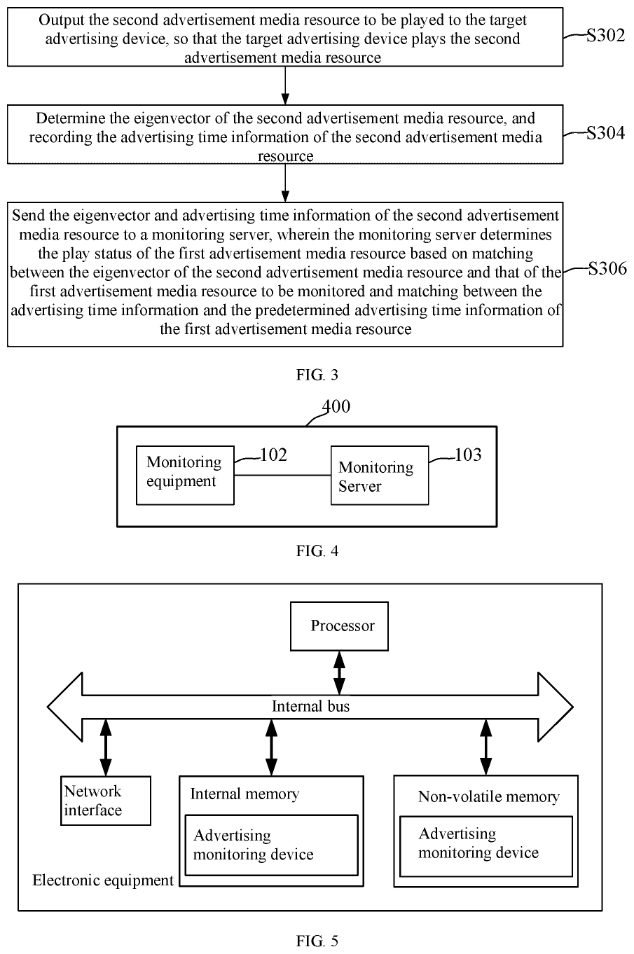

The detailed process for the monitoring equipment 102 to determine the eigenvector of the second advertisement media resource and record the information on advertising time of the second advertisement media resource will be described below in the description of the embodiment shown in FIG. 3 and will not be described here.

Step 206: determining the play status of the first advertisement media resource based on matching between the eigenvector of the second advertisement media resource and that of the first advertisement media resource and matching between the advertising time information and predetermined advertising time information of the first advertisement media resource.

In one example, step 206 may comprise: determining the play of the first advertisement media resource to be normal when the eigenvector of the second advertisement media resource matches that of the first advertisement media resource and the advertising time information of the second advertisement media resource matches the predetermined advertising time information. Here, the normal status may mean that the target advertising device has played the predetermined advertisement media resource (the first advertisement media resource) at the determined time for the determined duration, without misplay, missing, or delay.

In the second example, step 206 may comprise: determining the play of the first advertisement media resource to be abnormal when the eigenvector of the second advertisement media resource does not match that of the first advertisement media resource and/or the advertising time information of the second advertisement media resource does not match the predetermined advertising time information. Here, the abnormal status may mean that the advertisement media resource played by the target advertising device at the predetermined time is not the predetermined advertising media resource (the first advertising media resource), i.e., there is a misplay; or, the target advertising device plays the predetermined advertisement media resource at the predetermined time, but the play duration is not as the predetermined duration, i.e., there is a missing; or, the target advertising device plays the predetermined advertisement media resource for the predetermined duration, but at a delayed time, i.e., there is a delay; or, there are other abnormalities.

In the first and the second examples above, if the first advertisement media resource and the second advertisement media resource are both videos, and if the eigenvector of the first advertisement media resource is the vector formed by arranging the Hash values of all the multi-frame images contained in the first advertisement media resource in the play sequence and the eigenvector of the second advertisement media resource is the vector formed by arranging the Hash values of all the multi-frame images contained in the second advertisement media resource in the play sequence, determining whether the eigenvector of the second advertisement media resource matches that of the first advertisement media resource may include: when the Hash values in the eigenvector of the second advertisement media resource match the Hash values in the eigenvector of the first advertisement media resource in one-to-one correspondence, determining the eigenvector of the second advertisement media resource matches that of the first advertisement media resource. Otherwise, the eigenvector of the second advertisement media resource does not match that of the first advertisement media resource.

For example, assume the eigenvector of the second advertisement media resource is: {HASH1, HASH2, HASH3, HASH4}, and that of the first advertisement media resource is: {HASH5, HASH6, HASH7, HASH8}. When HASH1 is approximately equal to HASH5, HASH2 is approximately equal to HASH6, HASH3 is approximately equal to HASH7, and HASH4 is approximately equal to HASH8, the eigenvector of the second advertisement media resource may be determined as matching that of the first advertisement media resource. Otherwise, the eigenvector of the second advertisement media resource does not match that of the first advertisement media resource.

In the first and the second examples above, if the second advertisement media resource is a video, the advertising time information of the second advertisement media resource includes play timestamps of the multi-frame images contained in the second advertisement media resource, and the predetermined advertising time information includes a predetermined play time and a predetermined play duration of the first advertisement media resource. The play time and the play duration of the second advertisement media resource may be determined based on the play timestamps of the multi-frame images contained in the second advertisement media resource, and then determining whether the advertising time information of the second advertisement media resource matches the predetermined advertising time information of the first advertisement media resource may include: when the play time of the second advertisement media resource matches the predetermined play time and the play duration of the second advertisement media resource matches the predetermined play duration, determining the advertising time information of the second advertisement media resource matches the predetermined advertising time information. Otherwise, the advertising time information of the second advertisement media resource does not match the predetermined advertising time information.

For example, assume that the second advertisement media resource contains 2 frames of images, the starting timestamp of the first frame is 2019/05/01 12:00 and the ending timestamp is 2019/05/01 12:02, and the starting timestamp of the second frame is 2019/05/01 12:02 and the ending timestamp is 2019/05/01 12:04. Based on the timestamps of the two frames contained in the second advertisement media resource, it may be determined that the play time of the second advertisement media resource is 2019/05/01 12:00-12:04, and the play duration is 4 minutes. If the predetermined play time is also 2019/05/01 12:00-12:04 and the predetermined play duration is also 4 minutes, the play time of the second advertisement media resource may be determined as matching the predetermined play time, and that the play duration may be determined as matching the predetermined play duration.

With the advertising monitoring method provided by the embodiment shown in FIG. 2, the labor and time used for advertising monitoring can be reduced and the efficiency of advertising monitoring can be improved since the monitoring server can automatically determine the play status of the first advertisement media resource without onsite manual monitoring, based on matching between the eigenvector of the second advertisement media resource actually played by the target advertising device uploaded by the monitoring equipment of the target advertising device and the eigenvector of the first advertisement media resource to be monitored, and matching between advertising time information of the second advertisement media resource and the predetermined advertising time information of the first advertisement media resource.

A description is given above of an advertising monitoring method applied to a monitoring server provided by the embodiments of the specification, and an advertising monitoring method applied to the monitoring equipment is described below.

FIG. 3 shows an advertising monitoring method provided by the embodiments of the specification, which can be applied to the monitoring equipment 102 and may comprise:

Step 302: outputting the second advertisement media resource to be played to the target advertising device, so that the target advertising device plays the second advertisement media resource.

If the second advertisement media resource is a video, the monitoring equipment 102 may output images to the target advertising device 101 frame by frame in the play sequence of the multi-frame images contained in the video, so that the target advertising device 101 plays the video.

In some embodiments, before step 302, the method shown in FIG. 3 may also comprise: obtaining the second advertisement media resource from a local server of the monitoring equipment, where the second advertisement media resource in the local server of the monitoring equipment may be uploaded by advertisers (such as the user 105 in FIG. 1).

Step 304: determining the eigenvector of the second advertisement media resource, and recording the advertising time information of the second advertisement media resource.

In one example, if the first advertisement media resource is a video, step 304 may comprise: when the second advertisement media resource is output to the target advertising device, determining the Hash value of each image of the multi-frame images contained in the second advertisement media resource to obtain one or more Hash values, or when each image of the multi-frame images contained in the second advertisement media resource is output to the target advertising device, determining the Hash value of each frame to obtain one or more Hash values; then arranging the Hash values according to the play sequence of the multi-frame images to form a vector; and determining the vector as the eigenvector of the second advertisement media resource.

At the same time, when each frame in the multi-frame images contained in the second advertisement media resource is output to the target advertising device, the play timestamps of each frame (which may include a starting and an ending play timestamp) are recorded as part of the advertising time information of the second advertisement media resource.

Similarly, in another example, if the second advertisement media resource is an image, step 304 may comprise: determining the Hash value of the image to obtain a Hash value, and determining a one-element vector formed by the Hash value as the eigenvector of the second advertisement media resource. Correspondingly, when outputting the second advertisement media resource to the target advertising device, the play timestamps of the image (which may include a starting and an ending play timestamp) are recorded as part of the advertising time information of the second advertisement media resource.

Step 306: sending the eigenvector and advertising time information of the second advertisement media resource to a monitoring server, wherein the monitoring server determines the play status of the first advertisement media resource based on matching between the eigenvector of the second advertisement media resource and that of the first advertisement media resource to be monitored and matching between the advertising time information and the predetermined advertising time information of the first advertisement media resource.

For the details of “determining the play status of the first advertisement media resource based on matching between the eigenvector of the second advertisement media resource and that of the first advertisement media resource to be monitored and matching between the advertising time information and the predetermined advertising time information of the first advertisement media resource”, refer to the description of the embodiment shown in FIG. 2, which will not be repeated here.

The embodiment shown in FIG. 3 provides an advertising monitoring method. Since the monitoring equipment can determine and upload to the monitoring server the eigenvector and the advertising time information of the second advertisement media resource that has actually been played by the target advertising device, the monitoring server can automatically determine the play status of the first advertisement media resource without onsite manual monitoring, based on matching between the eigenvector of the second advertisement media resource and that of the first advertisement media resource to be monitored, and matching between the advertising time information and the predetermined advertising time information of the first advertisement media resource. Therefore, the labor and time for advertising monitoring can be reduced and the efficiency of advertising monitoring can be improved.

In addition to the advertising monitoring method shown in FIG. 2 and FIG. 3, the embodiments of the specification also provide an advertising monitoring system, as shown in FIG. 4, which may comprise the monitoring equipment 102 and the monitoring server 103.

The monitoring equipment 102 is configured to output the second advertisement media resource to be played to the target advertising device, so that the target advertising device plays the second advertisement media resource; determine the eigenvector of the second advertisement media resource and record advertising time information of the second advertisement media resource; and send the eigenvector and the advertising time information of the second advertisement media resource to the monitoring server.

The monitoring server 103 is configured to determine the eigenvector of the first advertisement media resource to be monitored; receive the eigenvector and the advertising time information of the second advertisement media resource uploaded from the monitoring equipment; and determine the play status of the first advertisement media resource based on matching between the eigenvector of the second advertisement media resource and that of the first advertisement media resource and matching between the advertising time information of the second advertisement media resource and the predetermined advertising time information of the first advertisement media resource.

In one example, the monitoring server 103 may be configured to determine the play of the first advertisement media resource to be normal when the eigenvector of the second advertisement media resource matches that of the first advertisement media resource and the advertising time information of the second advertisement media resource matches the predetermined advertising time information.

In some embodiments, if the first advertisement media resource and the first advertisement media resource are both videos, the monitoring equipment 102 may be configured to determine the Hash value of each image of the N-frame images contained in the second advertisement media resource to obtain N Hash values when the second advertisement media resource is output to the target advertising device 101; and to determine the vector (a row vector or a column vector) formed by arranging the N Hash values in the play sequence of the N-frame images as the eigenvector of the second advertisement media resource. The monitoring server 103 may be configured to simulate playing the first advertisement media resource to obtain M-frame images contained in the first advertisement media resource and determine the Hash value of each image in the M-frame images to obtain M Hash values; and to determine the vector (a row vector or a column vector) formed by arranging the M Hash values in the play sequence of the M-frame images as the eigenvector of the first advertisement media resource.

Based on this, the monitoring server 103 may be configured to determine that the eigenvector of the second advertisement media resource matches that of the first advertisement media resource when the N Hash values in the eigenvector of the second advertisement media resource match the M Hash values in the eigenvector of the first advertisement media resource in one-to-one correspondence. Accordingly, N equals M.

In another embodiment, if the second advertisement media resource is a video, the advertising time information of the second advertisement media resource includes play timestamps of the multi-frame images contained in the second advertisement media resource, and the predetermined advertising time information includes a predetermined play time and a predetermined play duration of the first advertisement media resource. The monitoring server 103 may be configured to determine that the advertising time information of the second advertisement media resource matches the predetermined advertising time information when the play time of the second advertisement media resource matches the predetermined play time based on the play timestamps of the multi-frame images contained in the second advertisement media resource and the play duration of the second advertisement media resource matches the predetermined play duration.

With the advertising monitoring system provided by the embodiments of the specification, the labor and time used for advertising monitoring can be reduced and the efficiency of advertising monitoring can be improved since the monitoring server can automatically determine the play status of the first advertisement media resource without onsite manual monitoring, based on matching between the eigenvector of the second advertisement media resource actually played by the target advertising device uploaded by the monitoring equipment of the target advertising device and the eigenvector of the first advertisement media resource to be monitored, and matching between the advertising time information of the second advertisement media resource and information on the predetermined advertising time information of the first advertisement media resource.

The electronic equipment provided in the embodiments of the specification is described below.

FIG. 5 is the schematic structural diagram of the electronic equipment of one embodiment in the specification. In reference to FIG. 5, at the hardware level, the electronic equipment includes a processor, and optionally internal buses, network interfaces, and memory. The memory may include an internal memory, for example, a high-speed random-access memory (RAM), and may also include a non-volatile memory, for example, at least one disk memory. The electronic equipment may also include the necessary hardware for other businesses.

The processor, network interfaces and memory may be connected to each other through internal buses, which may be of the Industry Standard Architecture (ISA), Peripheral Component Interconnect (PCI), or Extended Industry Standard Architecture (EISA). The buses may include address buses, data buses, and control buses. For ease of representation, only a two-way arrow is used in FIG. 5 to represent the buses, but it does not mean that there is only one bus or one type of bus.

The memory is used for storing programs. Specifically, the programs may comprise program codes, which include computer operation instructions. The memory may include an internal memory and a non-volatile memory, and provides instructions and data to the processor.

The processor reads the corresponding computer program from the non-volatile memory into the internal memory and then runs it, and this forms an advertising device at the logic level. The processor executes a program stored in the memory, and is used to perform the following operations:

determining the eigenvector of the first advertisement media resource to be monitored;

receiving the eigenvector and advertising time information of the second advertisement media resource uploaded by monitoring equipment of the target advertising device, wherein the second advertisement media resource is the advertisement media resource actually played by the target advertising device;

determining the play status of the first advertisement media resource based on matching between the eigenvector of the second advertisement media resource and that of the first advertisement media resource and matching between the advertising time information and the predetermined advertising time of the first advertisement media resource.

In some embodiments, the processor executes a program stored in the memory, and is used to perform the following operations:

outputting the second advertisement media resource to be played to the target advertising device, so that the target advertising device plays the second advertisement media resource;

determining the eigenvector of the second advertisement media resource, and recording the advertising time information of the second advertisement media resource;

sending the eigenvector and information on advertising time of the second advertisement media resource to a monitoring server, wherein the monitoring server determines the play status of the first advertisement media resource based on matching between the eigenvector of the second advertisement media resource and that of the first advertisement media resource to be monitored and matching between the advertising time information and the predetermined advertising time information of the first advertisement media resource.

The above-mentioned advertising monitoring method disclosed in the embodiment shown in FIG. 2 or FIG. 3 of the specification may be applied to a processor or implemented by a processor. The processor may be an integrated circuit chip with signal processing capabilities. In the implementation process, each step of the above method may be completed by an integrated logic circuit in the form of hardware in the processor or an instruction in the form of software. The above-mentioned processor may be a general-purpose processor, for example, a Central Processing Unit (CPU), or a Network Processor (NP); it may also be a Digital Signal Processor (DSP), an Application Specific Integrated Circuit (ASIC), a Field-Programmable Gate Array (FPGA), or other types of programmable logic devices, discrete gates or transistor logic devices, or discrete hardware components. Various methods, steps, and logic block diagrams disclosed in one or more embodiments of the specification may be implemented or executed. A general-purpose processor may be a microprocessor or any conventional processor. The steps of the method disclosed in connection with one or more embodiments of the specification may be directly embodied as being executed by a hardware decoding processor, or executed and completed by using a combination of hardware and software modules in the decoding processor. A software module may be located in a mature storage medium such as a random access memory, a flash memory, a read-only memory, a programmable read-only memory, an electrically erasable programmable memory, a register, etc. The storage medium is located in the memory, and the processor reads the information in the memory and completes the steps of the above method in combination with its hardware.

The electronic equipment may also execute the advertising monitoring method shown in FIG. 2 or FIG. 3, and the details will not be repeated here.

In addition to software implementation, the electronic equipment in the specification do not exclude other implementations, such as logic devices or a combination of software and hardware. In other words, the execution body of the following processing flow is not limited to the logical units but may also be hardware or logic devices.

The embodiments of the specification also provide a computer-readable storage medium, which stores one or more programs containing instructions that, when executed by portable electronic equipment comprising a plurality of applications, cause the portable electronic equipment to execute the method shown in FIG. 1 and in particular the following operations:

determining the eigenvector of the first advertisement media resource to be monitored;

receiving the eigenvector and advertising time information of the second advertisement media resource uploaded by monitoring equipment of the target advertising device, wherein the second advertisement media resource is the advertisement media resource actually played by the target advertising device;

determining the play status of the first advertisement media resource based on matching between the eigenvector of the second advertisement media resource and that of the first advertisement media resource and matching between the advertising time information and the predetermined advertising time information of the first advertisement media resource.

The embodiments of the specification also provide a computer-readable storage medium, which stores one or more programs containing instructions that, when executed by portable electronic equipment comprising a plurality of applications, cause the portable electronic equipment to execute the method shown in FIG. 1 and in particular the following operations:

outputting the second advertisement media resource to be played to the target advertising device, so that the target advertising device plays the second advertisement media resource;

determining the eigenvector of the second advertisement media resource, and recording the advertising time information of the second advertisement media resource;

sending the eigenvector and information on advertising time of the second advertisement media resource to a monitoring server, wherein the monitoring server determines the play status of the first advertisement media resource based on matching between the eigenvector of the second advertisement media resource and that of the first advertisement media resource to be monitored and matching between the advertising time information and the predetermined advertising time information of the first advertisement media resource.

The advertising monitoring device 600 and the advertising monitoring device 700 provided in the embodiments of the specification are described below.

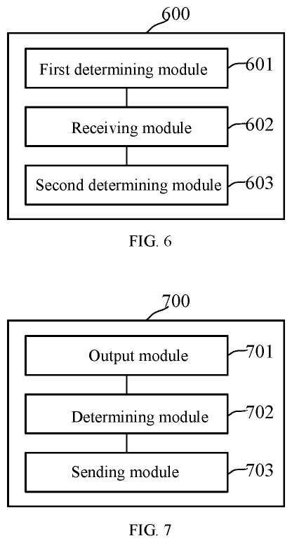

FIG. 6 is the schematic structural diagram of the advertising monitoring device 600 provided by the specification. In reference to FIG. 6, in one software implementation, the advertising monitoring device 600 may comprise the first determining module 601, a receiving module 602, and the second determining module 603.

The first determining module 601 is configured to determine the eigenvector of the first advertisement media resource to be monitored.

In one example, if the first advertisement media resource is a video, the first determining module 601 may be configured to simulate playing the first advertisement media resource to obtain multi-frame images contained in the first advertisement media resource; determine the Hash value of each image in the multi-frame images to obtain one or more Hash values; arrange the Hash values according to the play sequence of the multi-frame images to form a vector; and determine the vector as the eigenvector of the first advertisement media resource.

In another example, the device shown in FIG. 6 may also comprise: a resource receiving module, configured to receive the first advertisement media resource uploaded by a user before determining the eigenvector of the first advertisement media resource to be monitored.

The receiving module 602 is configured to receive the eigenvector and the advertising time information of the second advertisement media resource uploaded by the monitoring equipment of the target advertising device, wherein the second advertisement media resource is the advertisement media resource actually played by the target advertising device;

Similar to the eigenvector of the first advertisement media resource, if the second advertisement media resource is a video, the eigenvector of the second advertisement media resource may be the vector formed by arranging the Hash values of all the multi-frame images contained in the second advertisement media resource in the play sequence.

The advertising time information of the second advertisement media resource may include play timestamps recorded by the monitoring equipment 102 when the target advertising device plays the second advertisement media resource.

The second determining module 603 is configured to determine the play status of the first advertisement media resource based on matching between the eigenvector of the second advertisement media resource and that of the first advertisement media resource and matching between the advertising time information and the predetermined advertising time information of the first advertisement media resource.

In the first example, the second determining module 603 may be configured to determine the play of the first advertisement media resource to be normal when the eigenvector of the second advertisement media resource matches that of the first advertisement media resource and the advertising time information of the second advertisement media resource matches the predetermined advertising time information.

In the second example, the second determining module 603 may be configured to determine the play of the first advertisement media resource to be abnormal when the eigenvector of the second advertisement media resource does not match that of the first advertisement media resource and/or the advertising time information of the second advertisement media resource does not match the predetermined advertising time information.

In the first and the second examples above, if the first advertisement media resource and the second advertisement media resource are both videos, and if the eigenvector of the first advertisement media resource is the vector formed by arranging the Hash values of all the multi-frame images contained in the first advertisement media resource in the play sequence and the eigenvector of the second advertisement media resource is the vector formed by arranging the Hash values of all the multi-frame images contained in the second advertisement media resource in the play sequence, the second determining module may be configured to determine that the eigenvector of the second advertisement media resource matches that of the first advertisement media resource when the Hash values in the eigenvector of the second advertisement media resource match the Hash values in the eigenvector of the first advertisement media resource in a one-to-one correspondence. Otherwise, the eigenvector of the second advertisement media resource may be determined as not matching that of the first advertisement media resource.

In the first and the second examples above, if the second advertisement media resource is a video, the advertising time information of the second advertisement media resource includes play timestamps of the multi-frame images contained in the second advertisement media resource, and the predetermined advertising time information includes a predetermined play time and a predetermined play duration of the first advertisement media resource. The second determining module 603 may be configured to determine the play time and the play duration of the second advertisement media resource based on the play timestamps of the multi-frame images contained in the second advertisement media resource, and then determine that the advertising time information of the second advertisement media resource matches the predetermined advertising time information of the first advertisement media resource when the play time of the second advertisement media resource matches the predetermined play time and the play duration of the second advertisement media resource matches the predetermined play duration. Otherwise, the advertising time information of the second advertisement media resource does not match the predetermined advertising time information.

With the advertising monitoring device 600 provided by the embodiment shown in FIG. 6, the labor and time used for advertising monitoring can be reduced and the efficiency of advertising monitoring can be improved since the monitoring device can automatically determine the play status of the first advertisement media resource without onsite manual monitoring, based on matching between the eigenvector of the second advertisement media resource actually played by the target advertising device uploaded by the monitoring equipment of the target advertising device and the eigenvector of the first advertisement media resource to be monitored, and matching the advertising time information of the second advertisement media resource and the predetermined advertising time information of the first advertisement media resource.

The advertising monitoring device 600 can implement the method in the embodiment shown in FIG. 2. For details, refer to the advertising monitoring method in the embodiment shown in FIG. 2, which will not be repeated here.

FIG. 7 is the schematic structural diagram of the advertising monitoring device 700 provided by the specification. In reference to FIG. 7, in one software implementation, the advertising monitoring device 700 may comprise an output module 701, a determining module 702, and a sending module 703.

The output module 701 is configured to output the second advertisement media resource to be played to the target advertising device, so that the target advertising device plays the second advertisement media resource.

If the second advertisement media resource is a video, the output module 701 may output images to the target advertising device 101 frame by frame in the play sequence of the multi-frame images contained in the video, so that the target advertising device plays the video.

In some embodiments, the device shown in FIG. 7 may also comprise: a resource obtaining module, configured to obtain the first advertisement media resource from a local server of the monitoring equipment before outputting the second advertisement media resource to be played to the target advertising device.

The determining module 702 is configured to determine the eigenvector of the second advertisement media resource and record the advertising time information of the second advertisement media resource.

In one example, if the first advertisement media resource is a video, the determining module 702 may be configured to determine the Hash value of each image of the multi-frame images contained in the second advertisement media resource to obtain one or more Hash values when the second advertisement media resource is output to the target advertising device, or determine the Hash value of each frame to obtain one or more Hash values when each image of the multi-frame images contained in the second advertisement media resource is output to the target advertising device; and then arrange the Hash values according to the play sequence of the multi-frame images to form a vector; and determine the vector as the eigenvector of the second advertisement media resource.

At the same time, the determining module 702 may be configured to record the play timestamps of each frame as part of the advertising time information of the second advertisement media resource when each frame in the multi-frame images contained in the second advertisement media resource is output to the target advertising device.

The sending module 703 is configured to send the eigenvector and the advertising time information of the second advertisement media resource to a monitoring server, wherein the monitoring server determines the play status of the first advertisement media resource based on matching between the eigenvector of the second advertisement media resource and that of the first advertisement media resource to be monitored and matching between the advertising time information and the predetermined advertising time information of the first advertisement media resource.

With the advertising monitoring device 700 provided by the embodiment shown in FIG. 7, the eigenvector and the advertising time information of the second advertisement media resource that has actually been played by the advertising device, can be uploaded to the monitoring server, so that the monitoring server can automatically determine the play status of the first advertisement media resource without onsite manual monitoring, based on matching between the eigenvector of the second advertisement media resource and that of the first advertisement media resource to be monitored, and matching between the advertising time information and the predetermined advertising time information of the first advertisement media resource. As such, the labor and time used for advertising monitoring can be reduced and the efficiency of advertising monitoring can be improved.

The advertising monitoring device 700 can implement the method in the embodiment shown in FIG. 3. For details, refer to the advertising monitoring method in the embodiment shown in FIG. 3, which will not be repeated here.

In summary, the above description concerns merely the preferred embodiments of the specification, and is not intended to limit the protection scope of the present invention. Any modification, equivalent replacement, or improvement made within the essence and principle of one or more embodiments of the specification shall be included in the protection scope of one or more embodiments of the specification.

The system, apparatus, modules, or units described in the foregoing embodiments may be specifically implemented by a computer chip or entity, or a product with a certain function. A typical implementation device is a computer. Specifically, the computer may be, for example, a personal computer, a laptop computer, a cell phone, a camera phone, a smart phone, a personal digital assistant, a media player, a navigation device, an email device, a game console, a tablet computer, a wearable device, or a combination of any of the above.

Computer-readable media include permanent and volatile, mobile and non-mobile media that use any method or technique for information storage. Information may be computer-readable instructions, data structures, modules of a program, or other data. Examples of computer storage media include, but are not limited to, phase change random access memory (PRAM), static random access memory (SRAM), dynamic random access memory (DRAM), other types of random access memory (RAM), read-only memory (ROM), electrically erasable programmable read-only memory (EEPROM), flash memory or other memory technologies, compact disc read-only memory (CD-ROM), digital versatile discs (DVDs) or other optical storage, magnetic cassette tapes, magnetic tape storage or other magnetic storage devices or any other non-transmitting medium that may be used to store information that can be accessed by a computing device. As defined herein, computer-readable media do not include computer-readable transitory media, such as modulated data signals and carriers.

It should also be noted that the terms “including”, “comprising” or any other variants thereof are intended to denote non-exclusive inclusion, so that a process, method, product, or device that includes a series of elements includes not only those elements but also other elements not explicitly listed or those that are inherent to such a process, method, product, or device. When there are no more restrictions, an element limited by the expression “including one . . . ” does not exclude that there are other identical elements in the process, method, product, or equipment including the element.

Each embodiment in the specification is described in a progressive manner, and descriptions of the same or similar parts between different embodiments may be cross-referenced. The description of each embodiment is focused on the differences from other embodiments. In particular, since the system embodiment is basically similar to the method embodiment, the description is relatively simple. For relevant parts, refer to the description of the method embodiment.

What is claimed is:

1. An advertising monitoring method, applied to a monitoring server, comprising:
determining a first eigenvector of a first advertisement media resource to be monitored, wherein the first eigenvector comprises one or more first Hash values;
receiving advertising time information and a second eigenvector of a second advertisement media resource, wherein the second advertisement media resource is played by a target advertising device, and the second eigenvector comprises one or more second Hash values;
determining whether the advertising time information of the second advertisement media resource matches predetermined advertising time information of the first advertisement media resource and determining whether the first eigenvector matches the second eigenvector based on the one or more first Hash values and the one or more second Hash values; and
when the advertising time information matches the predetermined advertising information and the first eigenvector matches the second eigenvector, determining play status of the first advertisement media resource on the target advertising device is normal.

2. The method according to claim 1, wherein determining the first eigenvector of the first advertisement media resource comprises:
simulating playing the first advertisement media resource to obtain multi-frame images included in the first advertisement media resource;
determining a Hash value of each image in the multi-frame images to obtain the one or more first Hash values;
arranging the one or more first Hash values according to a first play sequence of the multi-frame images to form a vector; and
determining the vector as the first eigenvector of the first advertisement media resource.

3. The method according to claim 2, wherein the determining whether the first eigenvector matches the second eigenvector based on the one or more first Hash values and the one or more second Hash values comprises:
when the one or more second Hash values in the second eigenvector of the second advertisement media resource match the one or more first Hash values in the first eigenvector of the first advertisement media resource in a one-to-one correspondence, determining the second eigenvector of the second advertisement media resource matches the first eigenvector of the first advertisement media resource, wherein the second eigenvector of the second advertisement media resource being a vector formed by arranging the one or more second Hash values of multi-frame images included in the second advertisement media resource in a second play sequence.

4. The method according to claim 1, wherein the determining whether the advertising time information of the second advertisement media resource matches predetermined advertising time information of the first advertisement media resource comprises:
determining a play time and a play duration of the second advertisement media resource based on play timestamps of multi-frame images included in the second advertisement media resource; and
when the play time of the second advertisement media resource matches a predetermined play time of the first advertisement media resource and the play duration of the second advertisement media resource matches a predetermined play duration of the first advertisement media resource, determining the advertising time information of the second advertisement media resource matches the predetermined advertising time information of the first advertisement media resource.

5. The method according to claim 1, wherein the first advertisement media resource is an image, and determining the first eigenvector of the first advertisement media resource comprises:
determining a Hash value of the image; and
forming a one-element vector with the determined Hash value as the first eigenvector of the first advertisement media resource.

6. The method according to claim 1, comprising, before determining the first eigenvector of the first advertisement media resource:
receiving the first advertisement media resource uploaded by a user.

7. The method according to claim 1, wherein the first advertisement media resource is a video.

8. An advertising monitoring device, comprising one or more processors and a non-transitory computer-readable memory coupled to the one or more processors and configured with instructions executable by the one or more processors to perform operations comprising:
determining a first eigenvector of a first advertisement media resource to be monitored, wherein the first eigenvector comprises one or more first Hash values;
receiving advertising time information and a second eigenvector of a second advertisement media resource, wherein the second advertisement media resource is played by a target advertising device, and the second eigenvector comprises one or more second Hash values;
determining whether the advertising time information of the second advertisement media resource matches predetermined advertising time information of the first advertisement media resource and determining whether the first eigenvector matches the second eigenvector based on the one or more first Hash values and the one or more second Hash values; and
when the advertising time information matches the predetermined advertising information and the first eigenvector matches the second eigenvector, determining play status of the first advertisement media resource on the target advertising device is normal.

9. The advertising monitoring device according to claim 8, wherein determining the first eigenvector of the first advertisement media resource comprises:
simulating playing the first advertisement media resource to obtain multi-frame images included in the first advertisement media resource;
determining a Hash value of each image in the multi-frame images to obtain the one or more first Hash values;
arranging the one or more first Hash values according to a first play sequence of the multi-frame images to form a vector; and
determining the vector as the first eigenvector of the first advertisement media resource.

10. The advertising monitoring device according to claim 9, wherein the determining whether the first eigenvector matches the second eigenvector based on the one or more first Hash values and the one or more second Hash values comprises:
when the one or more second Hash values in the second eigenvector of the second advertisement media resource match the one or more first Hash values in the first eigenvector of the first advertisement media resource in a one-to-one correspondence, determining the second eigenvector of the second advertisement media resource matches the first eigenvector of the first advertisement media resource, wherein the second eigenvector of the second advertisement media resource being a vector formed by arranging the one or more second Hash values of multi-frame images included in the second advertisement media resource in a second play sequence.

11. The advertising monitoring device according to claim 8, wherein the determining whether the advertising time information of the second advertisement media resource matches predetermined advertising time information of the first advertisement media resource comprises:
determining a play time and a play duration of the second advertisement media resource based on play timestamps of multi-frame images included in the second advertisement media resource; and
when the play time of the second advertisement media resource matches a predetermined play time of the first advertisement media resource and the play duration of the second advertisement media resource matches a predetermined play duration of the first advertisement media resource, determining the advertising time information of the second advertisement media resource matches the predetermined advertising time information of the first advertisement media resource.

12. The advertising monitoring device according to claim 8, wherein the first advertisement media resource is an image, and determining the first eigenvector of the first advertisement media resource comprises:
determining a Hash value of the image; and
forming a one-element vector with the determined Hash value as the first eigenvector of the first advertisement media resource.

13. The advertising monitoring device according to claim 8, wherein before determining the first eigenvector of the first advertisement media resource, the operations further comprise:
receiving the first advertisement media resource uploaded by a user.

14. The advertising monitoring device according to claim 8, wherein the first advertisement media resource is a video.

15. A non-transitory computer-readable storage medium for advertising monitoring, storing instructions executable by one or more processors to cause the one or more processors to perform operations comprising:
determining a first eigenvector of a first advertisement media resource to be monitored, wherein the first eigenvector comprises one or more first Hash values;
receiving advertising time information and a second eigenvector of a second advertisement media resource, wherein the second advertisement media resource is played by a target advertising device, and the second eigenvector comprises one or more second Hash values;
determining whether the advertising time information of the second advertisement media resource matches predetermined advertising time information of the first advertisement media resource and determining whether the first eigenvector matches the second eigenvector based on the one or more first Hash values and the one or more second Hash values; and
when the advertising time information matches the predetermined advertising information and the first eigenvector matches the second eigenvector, determining play status of the first advertisement media resource on the target advertising device is normal.

16. The non-transitory computer-readable storage medium according to claim 15, wherein determining the first eigenvector of the first advertisement media resource comprises:
simulating playing the first advertisement media resource to obtain multi-frame images included in the first advertisement media resource;
determining a Hash value of each image in the multi-frame images to obtain the one or more first Hash values;
arranging the one or more first Hash values according to a first play sequence of the multi-frame images to form a vector; and
determining the vector as the first eigenvector of the first advertisement media resource.

17. The non-transitory computer-readable storage medium according to claim 16, wherein the determining whether the first eigenvector matches the second eigenvector based on the one or more first Hash values and the one or more second Hash values comprises:
when the one or more second Hash values in the second eigenvector of the second advertisement media resource match the one or more first Hash values in the first eigenvector of the first advertisement media resource in a one-to-one correspondence, determining the second eigenvector of the second advertisement media resource matches the first eigenvector of the first advertisement media resource, wherein the second eigenvector of the second advertisement media resource being a vector formed by arranging the one or more second Hash values of multi-frame images included in the second advertisement media resource in a second play sequence.

18. The non-transitory computer-readable storage medium according to claim 15, wherein the determining whether the advertising time information of the second advertisement media resource matches predetermined advertising time information of the first advertisement media resource comprises:
determining a play time and a play duration of the second advertisement media resource based on play timestamps of multi-frame images included in the second advertisement media resource; and
when the play time of the second advertisement media resource matches a predetermined play time of the first advertisement media resource and the play duration of the second advertisement media resource matches a predetermined play duration of the first advertisement media resource, determining the advertising time information of the second advertisement media resource matches the predetermined advertising time information of the first advertisement media resource.

19. The non-transitory computer-readable storage medium according to claim 15, wherein the first advertisement media resource is an image, and determining the first eigenvector of the first advertisement media resource comprises:
determining a Hash value of the image; and
forming a one-element vector with the determined Hash value as the first eigenvector of the first advertisement media resource.

20. The non-transitory computer-readable storage medium according to claim 15, wherein before determining the first eigenvector of the first advertisement media resource, the operations further comprise:
receiving the first advertisement media resource uploaded by a user.
